(19) United States
(12) Patent Application Publication
(10) Pub. No.: US 2014/0361055 A1
(43) Pub. Date: Dec. 11, 2014

(54) Hands-Free User Transport Harness

(71) Applicant: Thomas Myers, Florence, SC (US)

(72) Inventor: Thomas Myers, Florence, SC (US)

(21) Appl. No.: 14/296,667

(22) Filed: Jun. 5, 2014

Related U.S. Application Data
(60) Provisional application No. 61/831,965, filed on Jun. 6, 2013.

(51) Int. Cl. A61G 1/013; A45F 3/06

(52) U.S. Cl. CPC A61G 1/013; A45F 3/06
USPC 224/160

(57) ABSTRACT

A harness is provided for transporting an injured, incapacitated or disabled individual. The harness is designed to enable a single user to transport a person on their back, thereby freeing up the hands of the user while evenly distributing the weight of the person being carried. The device comprises panel having a proximal section, a mid-section, and a distal end. The panel includes first and second pairs of interconnecting straps. The first pair of interconnecting straps is located along the vertical plane of the proximal and distal ends of the harness, whereby the distal end of the panel is capable of folding upward and being connected to the straps of the distal end, thereby securing an individual therein. The proximal end also comprises a second pair of securement straps, whereby the second pair of straps wraps horizontally around the individual to further secure them within the harness.

### CROSS REFERENCE TO RELATED APPLICATION

This application claims the benefit of U.S. Provisional Application No. 61/831,965 filed on Jun. 6, 2013. The above identified patent application is herein incorporated by reference in its entirety to provide continuity of disclosure.

### BACKGROUND OF THE INVENTION

1. Field of the Invention

The present invention relates to user transportation harness. More specifically the invention relates to a backpack style harness that is adapted for supporting an injured person therein.

Individuals become injured or incapacitated during military missions. When this happens the individual must be quickly removed from the emergency situation and transported to a safer place. When in dangerous situations speed and safety are paramount, which are difficult to maintain during combat. The common solution for removing an injured individual is to transport them within a harness or a stretcher. With these devices the person in need is placed on the support device and carried to safety by one or more people. The individual can be laid across a stretcher, dragged behind the carrying individual, or supported on their back.

Harnesses are useful for carrying injured individuals; however difficulties can arise when attempting to transport individuals to safety when in the middle of a military combat zone. Additionally, traditional rescue apparatuses may require two individuals to complete the rescue; however, in emergency situations this is not often convenient or possible. Moreover, a majority of rescue harnesses require excessive setting up before use, which requires an excessive amount of time, energy, exposure to danger, and with more than a single person utilizing the device the dangers only increase. The longer it takes rescuers to assist an injured individual, the more likely the injured individual will sustain further complications. It is crucial to get the injured individuals to safety as soon as possible, especially if bleeding or internal bleeding is occurring.

Military professions may feel the risks of exposure and lack of convenience while setting up and transporting an individual on a harness or stretcher may outweigh the downsides of transporting without a stable structure. Moreover, more dangerous situations can develop if the rescuers are exposed to danger during their recovery mission. While going without an emergency transportation device may speed the process of evacuation, it does not facilitate a comfortable or safe experience for the injured individual, which is of the upmost importance.

There are several devices that attempt to provide efficient and safe means for transporting an injured person thereon. These devices come in the form of user transported harnesses and stretchers. Some of these devices can be operated by a single person, while others require the use of multiple individuals. The devices, while convenient, fail to address the setbacks of enabling a singular individual to operate the device in a hands-free manner while also evenly distributing the weight of the individual.

The present invention, however, pertains to a harness for transporting injured or incapacitated individuals, wherein the harness is designed for use by a single able-bodied individual while still enabling the use of the hands, which is of importance during rescue situations. The harness comprises a flexible sheet with a plurality of securement straps and quick connection/disconnection means hereon. The device can be laid on the ground and a person in need can be placed thereon. Thereafter the straps can be secured around the injured individual and the carrying straps can be utilized by the rescue individual support and transport and the injured individual in a piggyback manner. Additionally, use of the device evenly distributes the weight of the carried individual on the back of an individual and enables the individual to have full use of their hands and feet, thereby enabling the individual to move about and still providing use to others in an emergency situation.

2. Description of the Prior Art

Devices have been disclosed in the prior art that relate to user transport harnesses. These include devices that have been patented and published in patent application publications. These devices generally relate to stretchers and similar transport devices. The following is a list of devices deemed most relevant to the present disclosure, which are herein described for the purposes of highlighting and differentiating the unique aspects of the present invention, and further highlighting the drawbacks existing in the prior art.

One such prior art device, U.S. Pat. No. 7,607,184 to Goodner, Jr. provides a personal field stretcher that is collapsible. The field stretcher is designed into clothing, such as a jacket, and is adapted for carrying an injured or incapacitated individual in the line of duty. The collapsible stretcher projects upward and downward from the bottom of the jacket, thereby providing a platform for the securement of the individual in need of help. The prior art device, however, fails to provide a user support harness that is adapted to support an individual in a “piggyback” orientation similar to that as is provided by the present invention.

Another prior art device, U.S. Pat. No. 4,885,812 to Lindner provides a combination backpack and cot with detachable carrying straps. The device comprises a first orientation that is adapted for wearing on the back of an individual, and a second orientation that provides an elevated cot. The prior art device, however, fails to provide a means for supporting an injured individual on the back of a user.

Prior art device U.S. Pat. No. 7,252,214 to Krogh provides a harness for carrying a child therein. The harness comprises a first strap that extends around the chest and is supported on the shoulder of an individual. The harness further comprises a child-holding section designed for holding a child in a sitting orientation on the front or side of a parent. The prior art device, however, while holding a person in a sitting orientation, fails to provide a harness that is adapted for supporting an individual in a “piggyback” orientation.

Yet another prior art device, U.S. Pat. No. 7,086,091 to Jordan provides a full body harness. The harness is secured around the body of an individual by a plurality of straps, however, the device is utilized for supporting a singular person wearing the harness and is adapted for use in rescue situations when connected to a support line and is not designed for supporting an injured individual on the back of another individual.

U.S. Pat. No. 8,066,161 to Green discloses a device that provides a hands-free lifting and carrying apparatus. The device comprises a pair of body-worn garments that comprise straps that are adjustable for wearing on the front or back of the garment. Clips on the distal ends of the straps are adapted for securing on to a carrying apparatus, such as a stretcher. The device enables a pair of individuals to lift and support an injured person on the stretcher without requiring the individuals to use their hands.

Similarly, U.S. Pat. No. 4,286,740 to Knight provides a device that facilitates the hands-free lifting and carrying of an individual. The device comprises two pairs of backpacks that are separated from one another. From each of the backpacks there comprises a support means. Between the pairs of backpacks there is a stretcher-like device that comprises carrying straps that are secured onto a proximal and distal elevated horizontal pole that are secured onto the support means of the four backpacks. In use, the individuals may place an injured person on the stretcher, and may then put on the backpacks and lift and transport the individual to a desired area in a hands-free manner. While these similar prior art devices provide a hands-free means for lifting and transporting an injured person thereon, the devices, however, fail to provide a hands-free harness that carries an injured person in a “piggyback” orientation.

Finally, prior art device U.S. Pat. No. 5,662,339 to Svendsen provides an infant carrier and stroller combination is designed to be supported on the back of an individual. In use, an infant may be placed into the interior of the carrier, and the parent may pick up the carrier and support the carrier on their back with the attached straps. The prior art device, however, fails to provide a harness that is capable of being laid flat in order to secure a person therein when the plurality of straps are connected together. Further, the prior art device is configured for the transportation of infants, whereas the present invention is adapted for supporting injured or disabled individuals therein.

The present invention, however, provides a device that is adapted for supporting an injured or disabled person therein. The device is adapted for enabling a single user to transport an injured person therein while enabling complete use of the hands. The device is flexible to fit different body types, includes a plurality of quick connect/disconnect clips, and further includes mechanisms for lifting by helicopter if needed. The present invention provides a device that addresses the needs of military professionals, firefighters, emergency workers, and the like by providing a means for a single individual to carry another person. Further, the device comprises a means for quick connection for transportation by helicopter.

It is submitted that the present invention is substantially divergent in design elements from the prior art and consequently it is clear that there is a need in the art for an improvement to user transport devices. In this regard the instant invention substantially fulfills these needs.

### SUMMARY OF THE INVENTION

In view of the foregoing disadvantages inherent in the known types of user transportation harnesses now present in the prior art, the present invention provides a new harness wherein the same can be utilized for providing convenience for the user when carrying an injured person without the use of a user's hands is desired.

It is therefore an object of the present invention to provide a new and improved user transportation harness device that has all of the advantages of the prior art and none of the disadvantages.

It is another object of the present invention to provide a user transportation harness that is worn on a user in a backpack style manner.

Another object of the present invention is to provide user transportation harness that is adapted to support an injured person on the back of a user.

Yet another object of the present invention is to provide a user transportation harness that comprises a plurality of interconnecting straps that are adapted to secure an injured person within the harness.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 displays a spread out view of the user transport harness.

FIG. 2 displays a view of the user transport harness.

FIG. 3 displays a side view of the user transport harness.

FIG. 4 displays side view of the user transport harness in use.

FIG. 5 displays a rear view of the user transport harness in use.

### DETAILED DESCRIPTION OF THE INVENTION

Reference is made herein to the attached drawings. Like reference numerals are used throughout the drawings to depict like or similar elements of the user transport harness. For the purposes of presenting a brief and clear description of the present invention, the preferred embodiment will be discussed as used for supporting and transporting an injured or disabled person therein. The figures are intended for representative purposes only and should not be considered to be limiting in any respect.

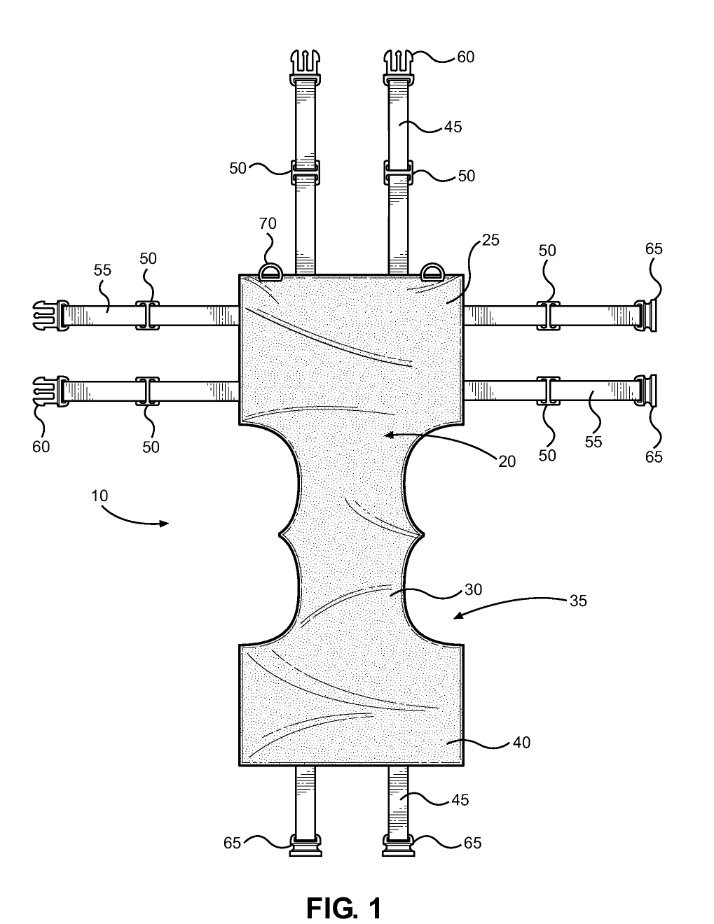

Referring now to FIG. 1, there is shown a spread out view of the user transport harness 10 of the present invention. The harness 10 is adapted for supporting an injured person on the back of a user, thereby providing a means for relocating an injured individual when in an emergency situation. The user transport harness comprises a pair of overlapping sheets that are sewn together to form a unified double panel 20 of material for supporting an individual thereon. The material can be of a conforming material in order to provide a tight fitting, a denim material for sturdiness, and/or flexible to provide a fitting for different sized individuals.

The unified panel 20 includes a proximal end 25, a mid-section 30, and a distal end 40, whereby the proximal end 25 comprises straps that are adapted to interconnect with straps of the distal end of the unified panel. A first 45 and second 55 pairs of flexible interconnecting straps are secured between the sheets of the unified panel 20. The first pair of straps 45 comprises a set of first and second vertical straps that lie on the vertical plane of the user transport harness 10, whereby the first strap is adjacent to the second vertical strap. The straps 45 each comprise a proximal end with a male securing means 60 and a distal end with a female receiving end 65 that is adapted to securely fasten onto the proximal securing means 60. The vertical straps 45 can be offered as extensions through the double panels 20 or they can be separate straps that extend outward from the proximal 25 and distal ends 40 of the panel. Additionally, the straps 45 can comprise an adjusting means 50 for altering the length of the straps in order to further provide a proper fitting around an injured individual.

The second pair of securing straps 55 comprises a set of first and second horizontal straps secured between the unified sheets within the proximal end 25 of the user transport harness 10, whereby the straps can be contained within the sheets or the horizontal straps can extend separately therefrom. The interconnecting straps are positioned adjacently to each other, and are similar in nature to the first pair of straps in that they comprise length adjusters 50 and male and female securing members. The straps 55 each comprise a proximal end with a proximal securing means 60, and a distal end with a distal securing 65 means that is adapted to securely fasten onto the proximal securing means 60.

The proximal 25 of end of the unified panel can also include a pair of D-rings 70 on the surface thereof. The D-rings 70 provide for quick connection to clips or other securement devices, thereby enabling transportation by a mechanical means, such as airlifting by helicopter. The D-rings 70 enable an injured individual to remain within the present invention after transportation on the back of the rescuer, and enables an efficient means for removing the person from a dangerous situation.

The mid-section 30 of the user transport harness 10 provides the primary support section of the harness. The mid-section 30 comprises a pair of cutouts 35, whereby the cutouts are located on opposing sides of the mid-section. The cutouts 35 are adjacent to each other and resemble a pair of half-circle indentations that are adjacent to each other and/or partially overlapping one another. The cutouts provide an opening through which the legs of an individual can comfortably reside along without restricting the movement of the legs within the user transport harness. Further, the mid-section 30 divides the harness into proximal 25 and distal sections 40 that can be folded upward during use, thereby providing a user supporting section and two opposing sections that overlap the front and back of an individual's torso.

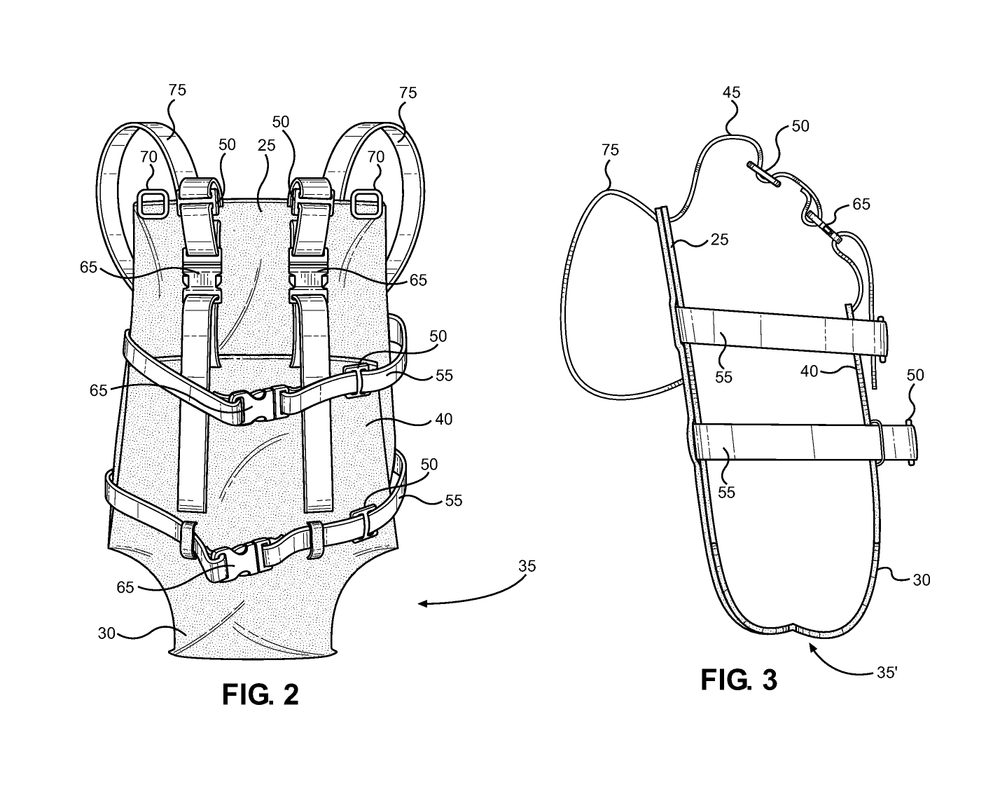

Referring now to FIG. 2, there is displayed a view of the user transport harness of the present invention. The unified harness is comprised of a flexible, sturdy, and unified panel 20, thereby enabling the distal end 40 to fold upward in relation to the proximal end 25 of the harness while maintaining and supporting an individual therein. The vertical plane of the user transport harness comprises a first pair 45 of interconnecting straps, whereby the straps are located adjacently to one another along the vertical plane. The straps comprise a first end that projects out of the proximal end 25 of the harness, and a second, opposing end that projects out of the distal end 40 of the harness. The distal end 40 of the harness can fold upwards, and thereafter the second end of the strap can project upwards and connect with the first end of the strap, thereby forming a unified strap.

The opposing (carrier facing) surface of the proximal end 25 of the user transport harness 10 comprises a pair of shoulder straps 75. The straps are designed for placement over the left and right shoulders of the individual in a backpack style manner. Further, the straps 75 are length adjustable in order to provide a snug fit against the body, which aids in preventing unwanted or excess movements when carrying an individual within the device. The carrying of an individual on the back allows for the full use of the hands while the orientation of the individual being carried allows a distribution of weight of the carried individual over a greater area, thus requiring less effort when moving the injured individual.

Referring now to FIG. 3, there is displayed a side view of the user transport harness of the present invention. The proximal end 25 of the harness further comprises a second pair horizontally aligned interconnecting straps 55. The straps comprise a first end and a second, opposing end that is adapted to interconnect with the first end of the same strap. The first end includes a proximal strap end male projection 60 and the second strap end includes a distal strap end female receiver 65 for securing the two strap ends together around the body of an injured or incapacitated individual. Similar to the vertically aligned first pair of straps, the second pair of straps is adjacently located to each other and can extend through the unified panel or can comprise separate strap sections that extend out of the sides of the unified panel. Additionally, each of the horizontal strap pairs 55 can include a length adjuster 50 for providing a tight fitting around the carried individual.

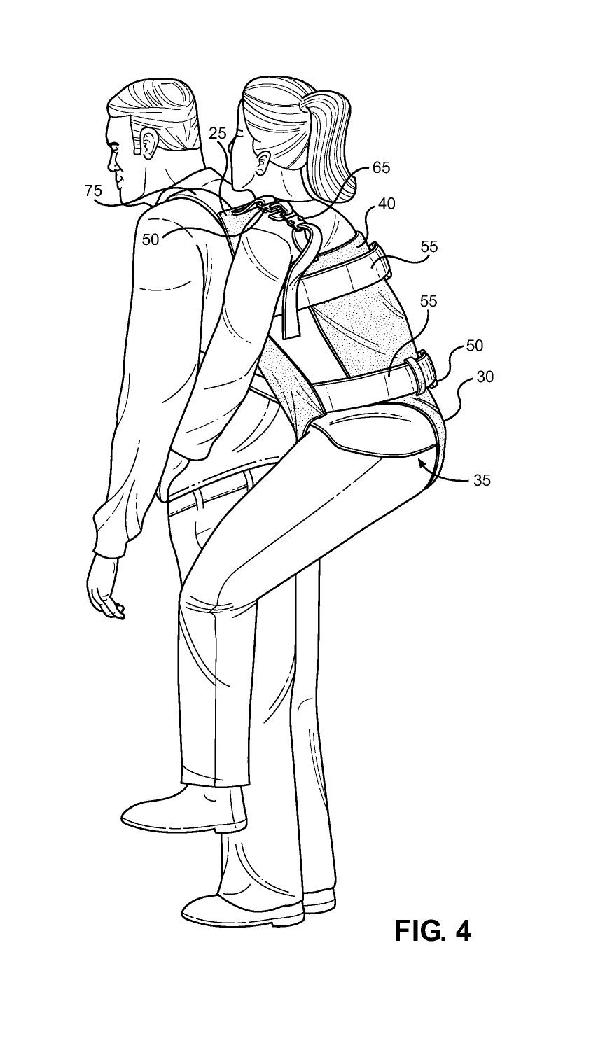

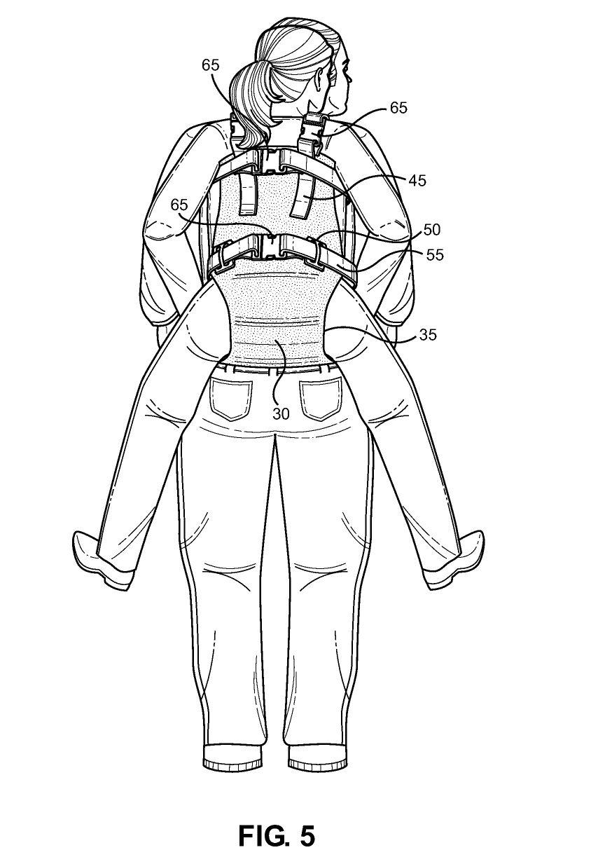

Referring no to FIGS. 4 and 5, there are displayed side and rear views of the user transport harness of the present invention. The present invention provides a means for transporting an injured, physically disabled, or incapacitated individual therein, which provides a benefit to military and medical workers in emergency situations that require the quick and safe removal of an individual from a dangerous location or situation. Further, the orientation of the carried individual facilitates the distribution of their weight along the length of the body of the carrier, thereby facilitating an easier transportation of the injured individual.

The user transport harness of the present invention is designed to enable a user to transport an injured or disabled person therein. If the injured individual is unable to move or incapacitated, the device 10 can be laid flat on the ground as shown in FIG. 1. The user may then lay an injured person on the harness in a position that orients their legs over the cutouts 35. Thereafter, the user may pull the distal section 40 upward and secure the ends of the vertical straps 45 together and subsequently secure the horizontal straps 55 around the individual, thereby securing them within the harness 10. The user can then put on the harness in a backpack style by putting on the shoulder straps 75. If however, the injured individual is capable of remaining upright or in a sitting position, the individual may secure the harness of the present invention around themselves. Thereafter the carrying individual can put on the adjustable shoulder straps 75 and transport the injured individual to safety.

The user transport harness provides a means for a user to transport an injured, incapacitated, or physically disabled person in a backpack or “piggyback” style that allows for full use of the hands while transporting. The harness comprises a first 45 and second pair 55 of straps. The first strap pair 45 extends vertically along the unified panel 20 and is adapted for bringing the proximal 25 and distal ends 40 of the unified panel 20 into proximity of each other and facilitates the securement of the device around the carried individual. The second pair of straps 55 is located along the proximal end 25 of the panel 20 and extends along a horizontal axis thereof. The combination of the adjustable horizontal 55 and vertical securement straps 45 provide a tight fitting around the individual, thereby providing a stable fitting within the harness. Further, the shoulder straps 75 can be adjusted by the carrying individual in order to provide a more comfortable fitting and to prevent excess movements during removal of the individual in need.

The device provides a convenient way to transport an injured person while freeing up the hands, thereby enabling a user to perform tasks that may be required in rescue situations. Additionally, the orientation of the injured person on the user's back provides a more even weight distribution than traditional harness designs. The harness is designed for the benefit of military personnel, emergency responders, hikers, outdoor enthusiasts, and those in need of transportation.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An apparatus adapted for hands-free transportation of another person, comprising;
a user transport harness comprising a panel having a proximal end, a mid-section, and a distal end;
said proximal end comprising at least one vertically orientated proximal strap and said distal end comprising at least one vertically oriented distal strap, whereby the end of each proximal strap and the end of each distal strap comprise securement ends adapted to join together each proximal strap and distal strap together at their ends;
said proximal end further comprising a horizontally extending proximal strap with opposing securing ends that are adapted for securement together;
and wherein said panel comprises a pair of adjustable shoulder straps.

2. The apparatus of claim 1, wherein said at least one vertically orientated proximal strap comprises a first and second vertically orientated proximal strap adjacent to one another.

3. The apparatus of claim 1, wherein said at least one vertically orientated distal strap comprises a first and second vertically orientated distal strap adjacent to one another.

4. The apparatus of claim 1, wherein said vertically orientated proximal strap and said vertically orientated distal strap extend through the panel and are part of a continuous strap.

5. The apparatus of claim 1, wherein said mid-section comprise a cutout portion adapted to accommodate the legs of a carried individual.

6. The apparatus of claim 5, wherein said cutout portion is located on opposing sides of said panel.

7. The apparatus of claim 5, wherein said cutout portion is comprises a first and second substantially half circle cutout adjacent to one another and overlapping each other.
